(19) United States
(12) Patent Application Publication
(10) Pub. No.: US 2024/0047901 A1
(43) Pub. Date: Feb. 8, 2024

(54) ELECTRICAL SET SCREW CONNECTOR SYSTEMS AND METHODS

(71) Applicant: Hubbell Incorporated, Shelton, CT (US)

(72) Inventor: Christopher Gilpin Chadbourne, Manchester, NH (US)

(73) Assignee: Hubbell Incorporated, Shelton (US)

(21) Appl. No.: 18/361,859

(22) Filed: Jul. 30, 2023

Related U.S. Application Data
(60) Provisional application No. 63/370,276, filed on Aug. 3, 2022.

(51) Int. Cl. H01R 4/36

(52) U.S. Cl. CPC H01R 4/36

(57) ABSTRACT

An electrical set screw connector system is provided. The system includes a connector body and a bit. The connector body has a set screw and a pressure limitation for mechanically and electrically securing a conductor cable therein. The pressure limitation corresponds to a torque limit applied to the set screw. The bit has a torque limiting region that separates a body mating portion from a tool mating portion. The body mating portion operatively mates with the set screw, while the tool mating portion operatively mates with a tool. The torque limiting region shears at the torque limit.

### CROSS REFERENCE TO RELATED APPLICATIONS

This application claims benefit of U.S. Provisional Application 63/370,276 filed Aug. 3, 2022, the entire contents of which are incorporated herein by reference.

### BACKGROUND

### 1. Field of the Invention

The present disclosure is related to electrical set screw connectors. More particularly, the present disclosure is related to systems and methods for electrical set screw connectors.

### 2. Description of Related Art

Electrical connectors are well known in the electrical connection arts. These electrical connectors can include lugs, splices, collars, terminals, and others connecting devices where a conductor is secured to a connector body.

Crimp connectors are designed to form a mechanical and electrical connection between a conductor and a body via crimp connection. Other connectors can be designed to form a mechanical and electrical connection between the conductor and the body via a welded or soldered connection. Still further connectors can be designed to form a mechanical and electrical connection between the conductor and the body via a set screw.

Each type of electrical connector presents different challenges to ensure the resultant electrical and mechanical connection meets known standards. In the example of electrical set screw connectors, the set screw acts as a pressure member to terminate the conductor to the body.

The consistent and repeatable application of pressure to effectively couple the conductor with the body is a critical component of the electrical transmission process. One way to ensure the set screw applies the correct pressure is to apply the set screw with a desired torque. Often times, the desired torque correlates with a requirement of a listing agency such as the Underwriter Laboratories or UL.

The amount of pressure required varies, based on numerous factors including the size of the conductor, the size of the body, the materials involved, the performance standard having jurisdiction over the application, among other variables.

Thus, differing solutions have been proposed to resolve this challenge in the market place with various levels of success, ease of use, and cost. For example, some prior art electrical set screw connectors require dedicated tools that can be expensive and/or difficult to use. Other prior art solutions require dedicated connectors—where connectors themselves have specialized set screw designs that can be costly to design, manufacture, and a large number of part numbers depending on the different desired torques that can be hard to manage.

Accordingly, it has been determined by the present disclosure that there is a need for systems and methods that overcome, alleviate, and/or mitigate one or more of the aforementioned and other deleterious effects of prior art electrical set screw connectors.

### SUMMARY

An electrical set screw connector system is provided. The system includes a connector body and a bit. The connector body has a set screw and a pressure limitation for mechanically and electrically securing a conductor cable therein. The pressure limitation corresponds to a torque limit applied to the set screw. The bit has a torque limiting region that separates a body mating portion from a tool mating portion. The body mating portion operatively mates with the set screw, while the tool mating portion operatively mates with a tool. The torque limiting region shears at the torque limit.

In some embodiments either alone or together with any one or more of the aforementioned and/or after-mentioned embodiments, the bit includes a cross-sectional shape configured to translating a torque from the tool to the set screw.

In some embodiments either alone or together with any one or more of the aforementioned and/or after-mentioned embodiments, the cross-sectional shape is selected from a group consisting of quad shaped, penta shaped, hex shaped, and TORX® shaped.

In some embodiments either alone or together with any one or more of the aforementioned and/or after-mentioned embodiments, the system further includes the tool and the tool has a bit securing device that secures the tool mating portion of the bit so that a torque provided by the tool through the bit securing device is translated to the bit.

In some embodiments either alone or together with any one or more of the aforementioned and/or after-mentioned embodiments, the tool is selected from a group consisting of a wrench, a cordless drill, a corded drill, a corded impact driver, a cordless impact driver, a manually operated drill, a pneumatic drill, and a pneumatic impact driver.

In some embodiments either alone or together with any one or more of the aforementioned and/or after-mentioned embodiments, the bit securing device is selected from a group consisting of a keyless chuck, a keyed chuck, and a collet chuck.

In some embodiments either alone or together with any one or more of the aforementioned and/or after-mentioned embodiments, the bit securing device is a collet chuck and the bit further includes a collet notch engageable with the collect chuck.

In some embodiments either alone or together with any one or more of the aforementioned and/or after-mentioned embodiments, the connector body and/or the set screw are formed of the same or different electrically conductive materials selected from a group consisting of tin, steel, copper, aluminum, silver, gold and alloys and plating thereof.

In some embodiments either alone or together with any one or more of the aforementioned and/or after-mentioned embodiments, the system further includes a plurality of bits, where each bit in the plurality of bits has a torque limiting region that shears at a different torque limit.

In some embodiments either alone or together with any one or more of the aforementioned and/or after-mentioned embodiments, the torque limiting regions have different dimensional properties configured to provide the different torque limits.

In some embodiments either alone or together with any one or more of the aforementioned and/or after-mentioned embodiments, the bit has an indica thereon that corresponds to the torque limit.

In some embodiments either alone or together with any one or more of the aforementioned and/or after-mentioned embodiments, the connector body has a second indica thereon that corresponds to the torque limit.

In some embodiments either alone or together with any one or more of the aforementioned and/or after-mentioned embodiments, the indica is selected from a group consisting of a color, text, a pattern, and any combinations thereof.

A method of electrically and mechanically connecting a conductor cable and a connector body is provided. The method includes the steps of: selecting a first combination of the connector body and the conductor cable for a particular application; selecting a second combination of a tool and a bit having a torque limitation corresponding to the first combination; retaining the bit in the tool; inserting the conductor cable into the connector body; operatively engaging the torque limiting bit into a set screw of the connector body; and using the tool to apply torque to the set screw until reaching the torque limitation, wherein the bit shears at the torque limitation.

In some embodiments either alone or together with any one or more of the aforementioned and/or after-mentioned embodiments, the method further includes removing a portion of the bit engaged with the set screw.

In some embodiments either alone or together with any one or more of the aforementioned and/or after-mentioned embodiments, the method further includes removing a portion of the bit engaged with the tool.

In some embodiments either alone or together with any one or more of the aforementioned and/or after-mentioned embodiments, the tool is selected from a group consisting of a wrench, a cordless drill, a corded drill, a corded impact driver, a cordless impact driver, a manually operated drill, a pneumatic drill, and a pneumatic impact driver.

In some embodiments either alone or together with any one or more of the aforementioned and/or after-mentioned embodiments, the torque limitation corresponds to a desired pressure applied to the conductor cable by the set screw.

In some embodiments either alone or together with any one or more of the aforementioned and/or after-mentioned embodiments, the step of retaining the bit in the tool includes retaining the bit in a bit retaining device selected from a group consisting of a keyless chuck, a keyed chuck, and a collet chuck.

In some embodiments either alone or together with any one or more of the aforementioned and/or after-mentioned embodiments, the method further includes the step of loosening the set screw and withdrawing the conductor cable from the connector body.

The above-described and other features and advantages of the present disclosure will be appreciated and understood by those skilled in the art from the following detailed description, drawings, and appended claims.

### DESCRIPTION OF THE DRAWINGS

FIG. 1 is a perspective views of an exemplary embodiment of an electrical set screw connector system according to the present disclosure prior to use;

FIG. 2 is a perspective views of the connector system of FIG. 1 during use;

FIG. 3 is a perspective views of the connector system of FIG. 1 after use;

FIG. 4 is a perspective view of a torque limited drive bit according to the present disclosure for use with the connector system of FIG. 1;

FIG. 5 is a side view of the bit of FIG. 4;

FIG. 6 is a schematic view of the bit of FIG. 4 configured with different torque settings;

FIGS. 7A-7D are exemplary embodiments of different electrical set screw connectors for use with the connector system of FIG. 1;

FIGS. 8-9 are views of an alternate exemplary embodiment of an electrical set screw connector system according to the present disclosure; and

FIG. 10 is a flow chart illustrating an exemplary embodiment of a method according to the present disclosure.

### DETAILED DESCRIPTION

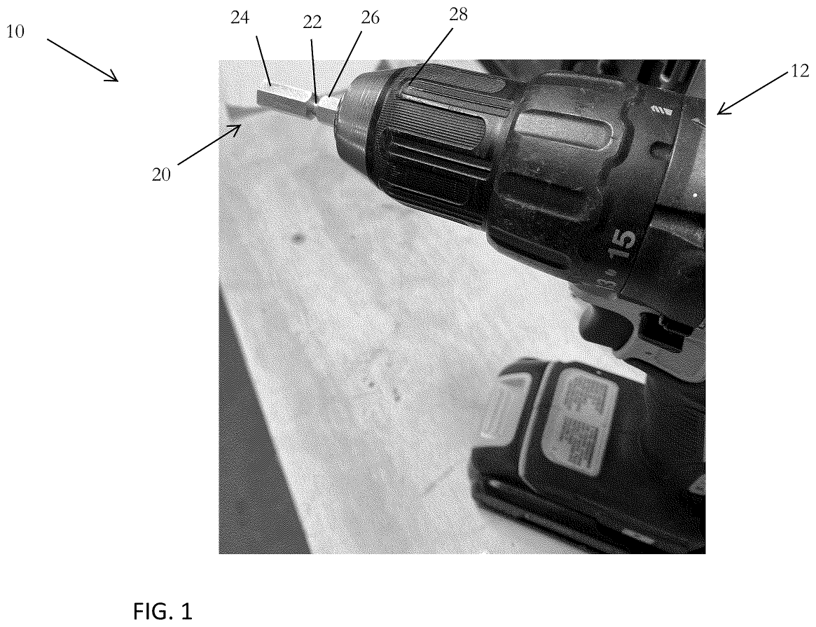

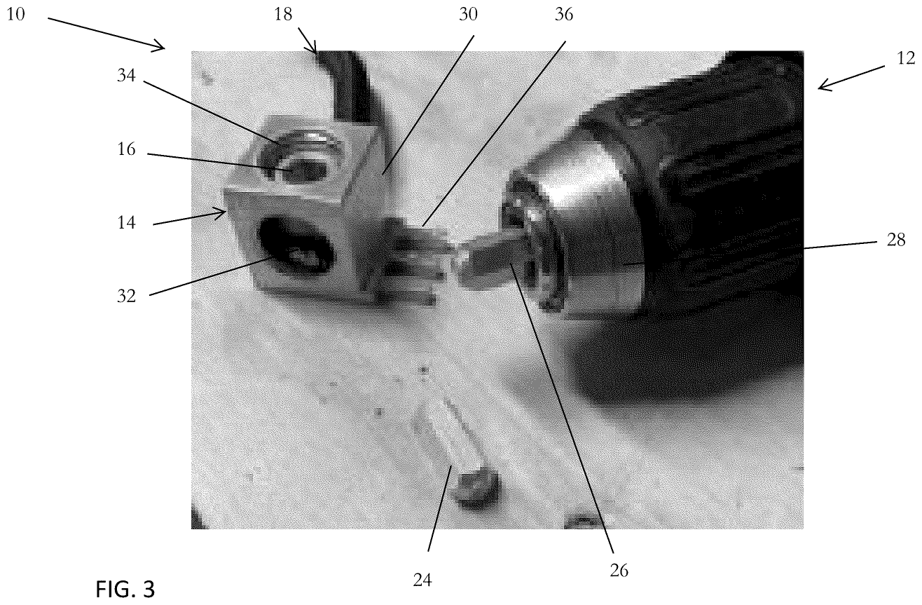

Referring to the drawings and in particular to FIGS. 1-3, an exemplary embodiment of an electrical set screw connector system according to the present disclosure is shown and is generally referred to by reference numeral 10. Connector system 10 combines the use of a torque application tool 12, a connector body 14 with a set screw 16, a conductor cable 18, and a torque limiting bit 20.

In this exemplary embodiment, connector body 14 is shown by way of example as a lug connector. Of course, it should be recognized that system 10 finds use with any connector body 14 with set screw 16 that forms a mechanical and electrical connection between the connector body and the conductor cable 18 such as, but not limited to, splices, collars, terminals, and others connecting devices.

Bit 20 is configured to be operatively mated to tool 12 and to limit the application of torque to screw 16 by shearing at a torque limiting region 22—into body and tool mating portions 24, 26, respectively. Region 22 can be modified such that different bits 20 shear at different torque levels.

In this manner, connector system 10 advantageously provides the user with an easy-to-use system to allows them to limit the torque applied to screw 16 by tool 12 by simply selecting bit 20 with the desired torque limit.

Connector system 10 provides a solution that separates the shear-functionality necessary for limiting torque from tool 12 and connector body 14—allowing the use of standard or off the shelf tools and connector bodies. Rather, the solution of connector system 10 resolves these issues by providing frangible bits 20—that are configured to shear at differing torque levels. This allows the installer to ensure that set screw 16 applies the desired torque in an easy and repeatable manner—while mating the frangibility with the lowest cost component—the bit.

Moreover, connector system 10 allows for the later removal of conductor cable 18 from connector body 14 after initial installation by leaving set screw 16 intact and unmodified. Thus, connector system 10 allows connector body 14 to be used over and over again—without modification—and to be reinstalled at the desired torque over and over again.

Power tool 12 illustrated as a cordless drill that includes bit securing device 28 such as a keyless chuck. Here, bit 20 is mated directly to device 28 in a known manner. Thus, connector system 10 requires the installer to have no specialized tools—but rather makes use of common tools that the installer already has and uses.

Connector body 14 includes a main body 30 with a conductor opening 32 and a threaded bore 34 that threadably receives set screw 16. Connector body 14, in the illustrated embodiment formed as a lug connector, includes a plurality of pads 36 depending from main body 30, where the pads are configured to mate with another connector (not shown) in a known manner.

Connector body 14 and set screw 16 can be formed of the same or different electrically conductive materials. For example, it is contemplated by the present disclosure for connector body 14 and/or set screw 16 to be made of pure, alloyed, or plated conductive metallic materials including materials such as, but not limited, to tin, steel, copper, aluminum, silver, gold, and the like.

Conductor cable 18 is positioned into connector body 14 through opening 32. Conductor cable 18 can, in some embodiments, include an insulating layer 38 over a conducting portion (not shown). When insulating layer 38 is present, the use of connector system 10, includes first stripping or removing a portion of the insulating layer that is to be inserted into connector body 14.

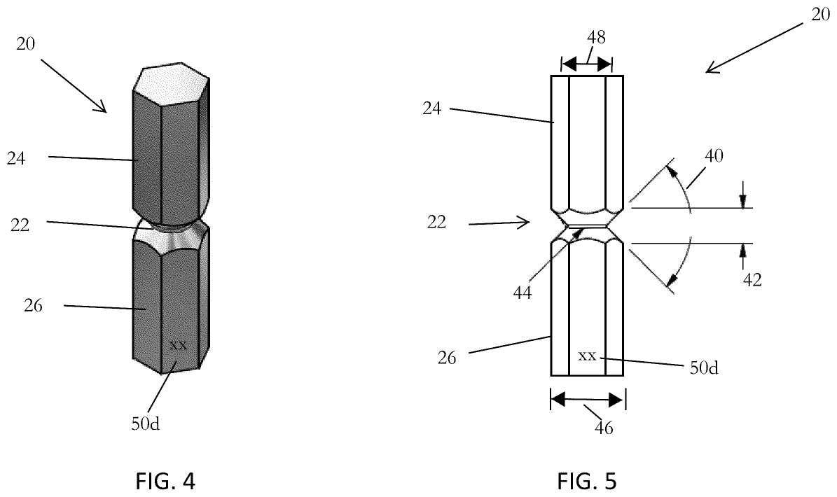

Bit 20 is described in more detail with simultaneous reference to FIGS. 4-6.

Bit 20 is made of a simple stock material having a cross-sectional shape capable of translating rotational movement of tool 12 to rotational movement of set screw 16. For example, bit 20 can have a cross-sectional shape such as, but not limited to, quad shaped, penta shaped, hex shaped; TORX® shaped, or other suitable cross-section.

Bit 20 is further configured so that torque limiting region 22 separates body mating portion 24 from tool mating portion 26. In this manner, once the torque applied by tool 12 to bit reaches a predetermined limit, the bit shears so that tool mating portion 26 can no longer apply additional torque to body mating portion 24—and hence so that the body mating portion can no longer apply additional torque to set screw 16 or conductor cable 18.

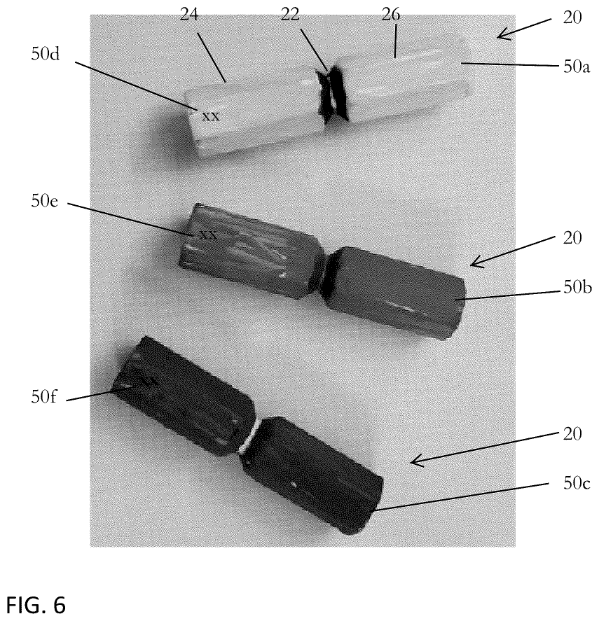

Torque limiting portion 22 can be configured to shear at different torque levels by adjusting and changing one or more of material properties, physical properties, and dimensional properties of bit 20. Different dimensional properties of bit 20 are shown in FIG. 5. Here, torque limiting portion 22 is shown having dimensional properties such as, but not limited, to an angular dimension 40, a length dimension 42, a gap dimension 44, a total diameter 46, and a region diameter 48. Adjustment to one or more of the dimensional properties of bit 20 can be used to change the torque limit at which torque limiting portion 22 shears.

In the embodiment where bit 20 is made of a single cross-sectional shape of stock, torque limiting portion 22 can be provided by a simple machining step to modify the stock to shear at the desired torque limit.

It should be recognized that bit 20 is illustrated by way of example having body mating portion 24 and tool mating portion 26 with the same total diameter 46 and the same hex bit design. Of course, it is contemplated by the present disclosure for connector system 10 to find use with bits 20 having portion 24, 26 that are the same or different from one another in terms of total diameter 46 and/or outer shape.

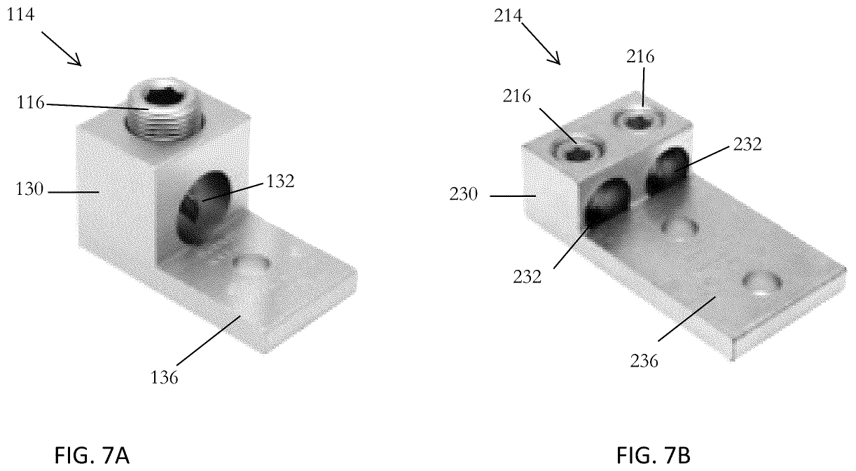

In some embodiments, connector system 10 can include indicia defined on bits 20 so that the installer can easily and repeatably select the bit with the desired torque limit. In some embodiments and with reference to FIG. 6, bits 20 can have indicia 50a, 50b, 50c in the form of different colors that relate to different torque limits.

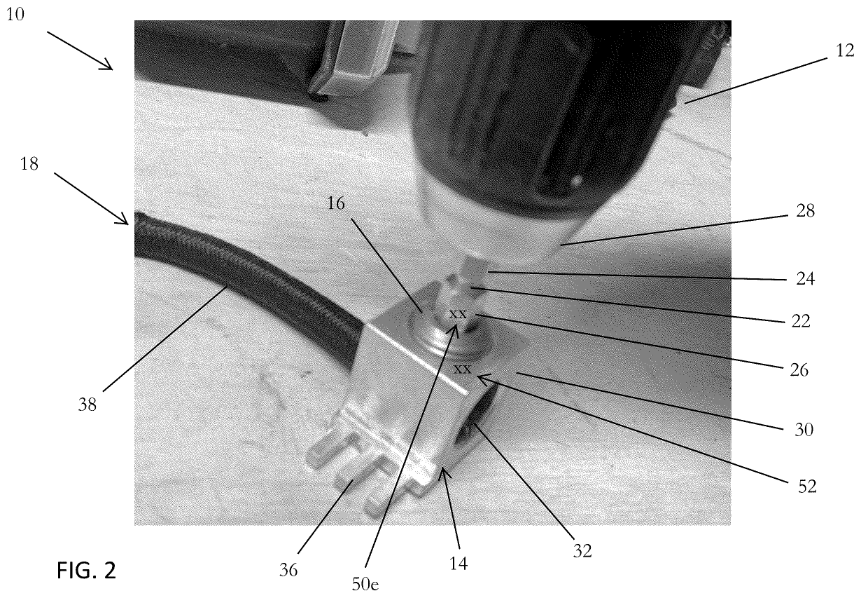

In other embodiments, bits 20 can have indicia 50d, 50e, 50f in the form of text or patterns that relate to different torque limits. Preferably, indica 50d, 50e, 50f in the form of text or patterns are positioned on body mating portion 24 so that the indicia can be seen when bit 20 is installed in tool 12. In still other embodiments shown in FIG. 2, indica 50d, 50e, 50f in the form of text or patterns are positioned on body mating portion 24 at a location where the indicia can be seen when bit 20 is in set screw 16.

In still other embodiments, connector body 14 can include matching indica that ensures the installer selects the proper bit 20. Thus and as shown in FIG. 2, connector body 14 can include indica 52 in the form of text, patterns, or colors that match the indica on the desired bit

It should be recognized that connector system 10 is shown in FIGS. 1-3 with in use with connector body 14 that includes main body 30 and pad 36. Of course, it is contemplated by the present disclosure for connector system 10 to find use with connector bodies of any configuration that include main body 30 having conductor opening 32 and the threaded bore that threadably receives set screw 16.

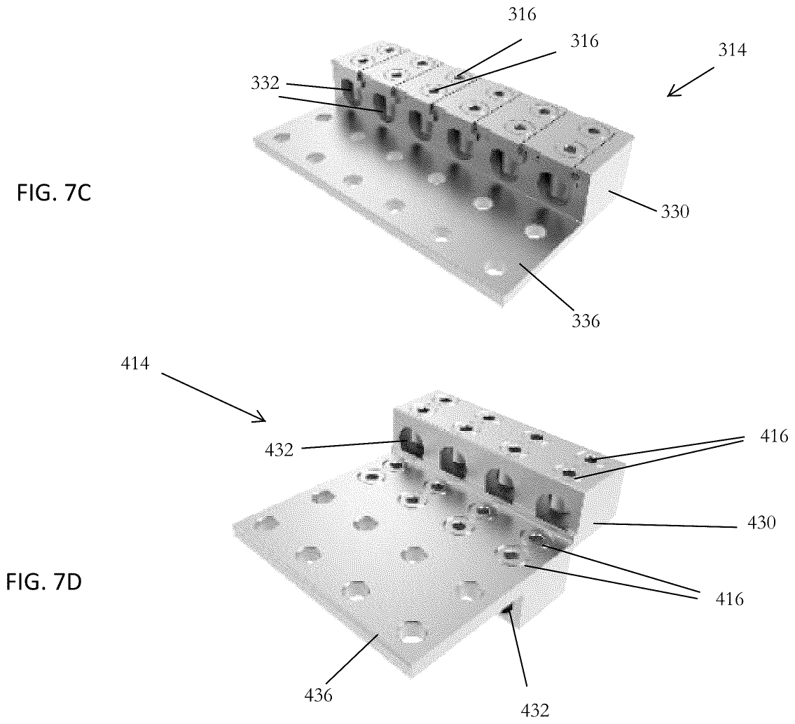

For example and with reference to FIGS. 7A-7D, alternate exemplary embodiments of the connector body that are contemplated for use with the connector system 10 of the present disclosure are shown.

The embodiment in FIG. 7A illustrates connector body 114 having main body 130 with a single set screw 116, opening 132, and pad 136. Thus, connector body 114 allows connection of a single conductor when used with connector system 10.

The embodiment in FIG. 7B illustrates connector body 214 having main body 230 with a pair of set screw 216/opening 232 and a single pad 236. Thus, connector body 214 allows connection of two conductors when used with connector system 10.

The embodiment in FIG. 7C illustrates connector body 314 having main body 330 with more than two set screws 316 for each opening 332 and a single pad 336. Here, connector body 314 is shown as a lay-in style configuration. Thus, connector body 314 allows connection of any desired number of conductors when used with connector system 10.

The embodiment in FIG. 7D, similar to connector body 314, connector body 414 has main body 430 with more than two set screws 416 for each opening 432 and a single pad 436. Here, connector body 414 is shown as a stacked style configuration. Thus, connector body 414 allows connection of any desired number of conductors when used with connector system 10.

It should be recognized that connector system 10 is shown in FIGS. 1-3 with power tool 12 illustrated as a cordless drill having bit securing device 28 in the form of a keyless chuck with bit 20 is mated directly to the keyless chuck.

Of course, it should be recognized that connector system 10 is not limited to use with cordless drills—but rather can find use with wrenches, corded drills, cordless or corded impact drivers, manually operated drills, pneumatic drills, pneumatic impact drivers, and others.

Further, it should be recognized that connector system 10 is not limited to use with bit securing device 28 in the form of the keyless chuck—but rather can find use with any other common bit securing devices such as, but not limited to, keyed chucks, collet chucks, and others. Moreover, the bit securing device 28 can be a socket and/or a bit driver—that allows system 10 to find use with common hand tools such as ratchet wrenches.

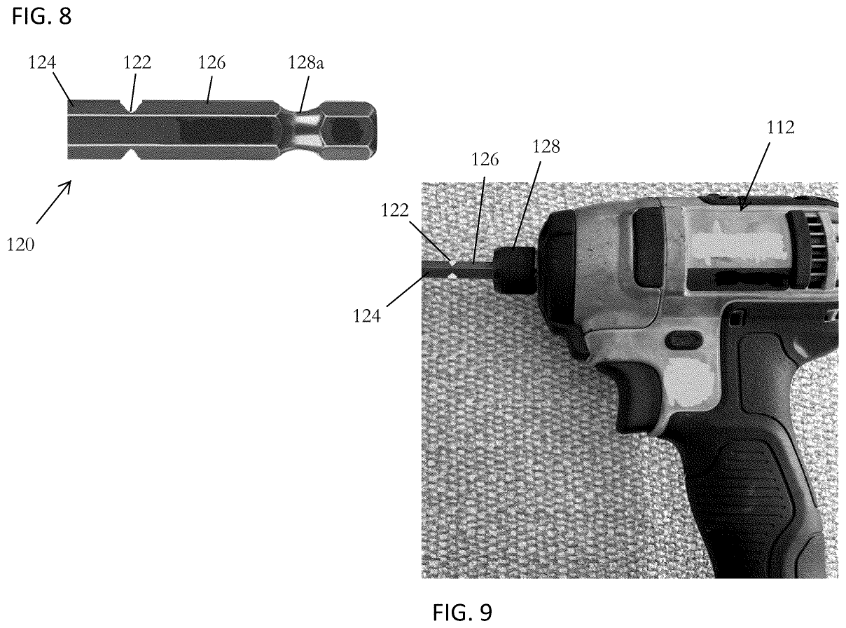

For example and with reference to FIGS. 8-9, connector system 10 is shown in use with a cordless impact driver 112 having a bit securing device 128 in the form of a collet chuck. Here, bit 120 is specifically configured with a collet notch 128a that operatively couples with device 128 in a known manner.

Bit 120 includes torque limiting region 122 separating body and tool mating portions 124, 126, respectively, in the manner discussed above. Here, collet notch 128a is positioned on tool mating portion 126 of bit 120.

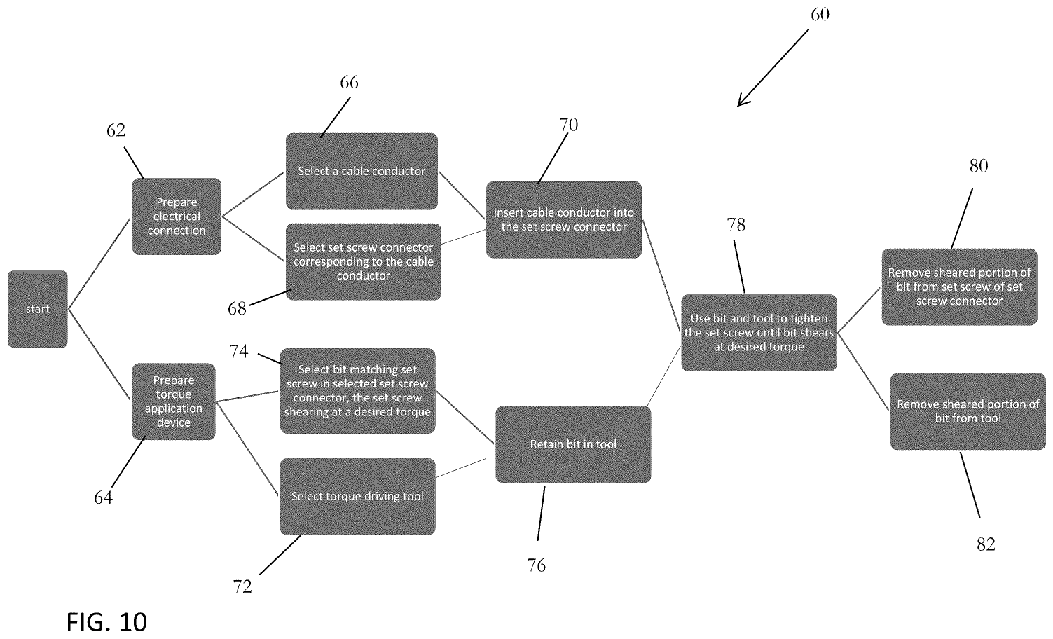

Referring now to FIG. 10, methods of using connector system 10 is shown and is generally referred to by reference numeral 60. During method 60, the components of the electrical connection are prepared at step 62, while the torque application device is prepared at step 64.

Preparation step 62 includes selecting the correct combination of connector body 14 and conductor cable 18 for a particular application in steps 66, 68, respectively—then inserting the conductor cable into the connector body at step 70.

Preparation step 64 includes selecting the correct combination of tool 12 and bit 20 for the combination of conductor cable 18 and connector body 14 at steps 72, 74, respectively—then retaining bit 20 in tool 20 at step 76.

Once the preparation steps 62, 64 are completed, method 70 continues at step 78 where set screw 16 and bit 20 are operatively coupled to one another and tool 12 is activated to torque the set screw until the bit shears at region 22.

Finally, body mating portion 24 of bit 20 is removed from set screw 16 and tool mating portion 26 is removed from tool 12 at steps 80, 82, respectively.

Method 60 ensures that set screw 16 applies the desired pressure on conductor cable 18 using standard tool 12 and standard connector body 14—and leaves the set screw unmodified so that the screw can later be loosened and retightened as many times as needed.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### PARTS LIST

connector system 10
torque application tool 12
connector body 14
set screw 16
conductor cable 18
torque limiting bit 20
torque limiting region 22
body mating portion 24
tool mating portion 26
bit securing device 28
main body 30
conductor opening 32
threaded bore 34
pad 36
insulating layer 38
angular dimension 40
length dimension 42
gap dimension 44
total diameter 46
region diameter 48
color indicia 50a-50c
text/pattern indicia 50d-50f
matching indica 52
connector body 114
main body 130
single set screw 116
opening 132
pad 136
connector body 214
main body 230
set screw 216
conductor opening 232
pad 236
connector body 314
main body 330
set screws 316
conductor opening 332
pad 336
connector body 414
main body 430
set screw 416
conductor opening 432
pad 436
impact driver 112
bit securing device 128
bit 120
collet notch 128a
torque limiting region 122
body mating portion 124
tool mating portion 126
method 60
preparation step 62
preparation step 64
connector selection step 66
cable selection step 68
insertion step 70
tool selection step 72
bit selection step 74
bit retaining step 76
set screw torquing step 78
removal steps 80, 82

What is claimed is:

1. An electrical set screw connector system, comprising:
a connector body with a set screw, the connector body having a pressure limitation for mechanically and electrically securing a conductor cable therein, the pressure limitation corresponding to a torque limit applied to the set screw; and
a bit having a torque limiting region that separates a body mating portion from a tool mating portion, the body mating portion being configured to operatively mate with the set screw, the tool mating portion being configured to operatively mate with a tool,
wherein the torque limiting region shears at the torque limit.

2. The connector system of claim 1, wherein the bit comprises a cross-sectional shape configured to translating a torque from the tool to the set screw.

3. The connector system of claim 2, wherein the cross-sectional shape is selected from a group consisting of quad shaped, penta shaped, hex shaped, and TORX® shaped.

4. The connector system of claim 1, further comprising the tool, wherein the tool comprises a bit securing device configured to operatively secure the tool mating portion of the bit so that a torque provided by the bit securing device is translated to the bit.

5. The connector system of claim 4, wherein the tool is selected from a group consisting of a wrench, a cordless drill, a corded drill, a corded impact driver, a cordless impact driver, a manually operated drill, a pneumatic drill, and a pneumatic impact driver.

6. The connector system of claim 4, wherein the bit securing device is selected from a group consisting of a keyless chuck, a keyed chuck, a collet chuck, a socket, and a bit driver.

7. The connector system of claim 4, wherein the bit securing device is a collet chuck and wherein the bit further comprises a collet notch operatively engageable with the collect chuck.

8. The connector system of claim 1, wherein the connector body and/or the set screw are formed of the same or different electrically conductive materials selected from a group consisting of tin, steel, copper, aluminum, silver, gold and alloys and plating thereof.

9. The connector system of claim 1, wherein the system further comprises a plurality of bits, each bit in the plurality of bits having a torque limiting regions that shears at a different torque limit.

10. The connector system of claim 9, wherein the torque limiting regions have different dimensional properties configured to provide the different torque limits.

11. The connector system of claim 1, wherein the bit has an indica thereon that corresponds to the torque limit.

12. The connector system of claim 11, wherein the connector body has a second indica thereon that corresponds to the torque limit.

13. The connector system of claim 11, wherein the indica is selected from a group consisting of a color, text, a pattern, and any combinations thereof.

14. A method of electrically and mechanically connecting a conductor cable and a connector body, comprising:
selecting a first combination of the connector body and the conductor cable for a particular application;
selecting a second combination of a tool and a bit having a torque limitation corresponding to the first combination;
retaining the bit in the tool;
inserting the conductor cable into the connector body;
operatively engaging the torque limiting bit into a set screw of the connector body; and
using the tool to apply torque to the set screw until reaching the torque limitation, wherein the bit shears at the torque limitation.

15. The method of claim 14, further comprising removing a portion of the bit engaged with the set screw.

16. The method of claim 14, further comprising removing a portion of the bit engaged with the tool.

17. The method of claim 14, wherein the tool is selected from a group consisting of a wrench, a cordless drill, a corded drill, a corded impact driver, a cordless impact driver, a manually operated drill, a pneumatic drill, and a pneumatic impact driver.

18. The method of claim 14, wherein the torque limitation corresponds to a desired pressure applied to the conductor cable by the set screw.

19. The method of claim 14, wherein the step of retaining the bit in the tool comprises retaining the bit in a bit securing device selected from a group consisting of a keyless chuck, a keyed chuck, a collet chuck, a socket, and a bit driver.

20. The method of claim 14, further comprising loosening the set screw and withdrawing the conductor cable from the connector body.
